(19) United States
(12) Patent Application Publication
(10) Pub. No.: US 2003/0233569 A1
(43) Pub. Date: Dec. 18, 2003

(54) Recognition plan/goal abandonment

(76) Inventors: Christopher W. Geib, Minneapolis, MN (US); Robert P. Goldman, Minneapolis, MN (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/348,264

(22) Filed: Jan. 21, 2003

Related U.S. Application Data
(60) Provisional application No. 60/351,300, filed on Jan. 22, 2002.

(51) Int. Cl. G06F 11/30

(52) U.S. Cl. 713/200

(57) ABSTRACT

A plan recognition method is implemented by a processing system and includes monitoring actions of a user, recognizing a plan of the user based on the monitored actions, and recognizing an abandonment of the plan based on the monitored actions.

### RELATED APPLICATIONS

This application claims the benefit of Provisional Application Serial No. 60/351,300 filed on Jan. 22, 2002.

### TECHNICAL FIELD OF THE INVENTION

The present invention relates to the recognition of plan/goal abandonment. For convenience, plan/goal abandonment is referred to below simply as goal abandonment. The present invention may be used, for example, to make critical computer systems more secure in such applications as energy, chemicals, transportation, defense, etc.

### BACKGROUND OF THE INVENTION

Security measures such as firewalls, cryptography, intrusion detection, network management, and passwords have been used in an attempt to make computer systems more resistant to unauthorized access. But even with these measures, computer systems remain vulnerable and can be exploited by hackers as well as by insiders who have legitimate access to at least portions of the computer systems. For example, insiders (who may include authorized users) are currently able to do largely as they please, and outsiders (such as hackers) can slip through the vulnerabilities in the security measures currently in use to gain authorization. The list of vulnerabilities of computer systems is large and growing.

In order to mitigate these vulnerabilities, various commercial-off-the-shelf (COTS) software packages have been developed. These packages typically place security as a distinctly secondary goal behind the goals of power and convenience. There is also a trend that relates to the software monoculture typified by attempts at software standardization. However, while it is easier to manage training and installation when all of the nodes of a system are identically configured, this node standardization amplifies the risk of unauthorized access. If one node in the system is susceptible to some vulnerability, nearly all of the nodes in the system are likewise susceptible. The success of viruses and worms such as Melissa, NIMDA, CodeRed, etc. in bringing corporate networks to a standstill is a recurring demonstration of this weakness.

Critical systems warrant a further layer of security. Security systems currently exist that, in a rudimentary way, predict likely outcomes of user commands. These security systems use physical (or other) models to reason out the effect of certain commands on a protected asset. For example, mathematical models are currently used in “power system security” analysis. That is, the operator of an electric power grid may use a mathematical model of load, power generation, voltage, and current everywhere over the power grid to make sure that planned changes will leave the grid in a stable safe state, even if one or more faults occur. Thus, before a proposed power transfer from point A to point B is implemented, the model simulates various possible line outages that could occur in order to make sure that, in spite of such outages (or other planned transfers), the power grid will remain in a stable state (no overloads, blackouts, etc.). A basic reference on this topic is a text entitled “Power Generation, Operation and Control”, by Allen Wood and Bruce Wollenberg.

For the most part, current computer systems promptly obey any commands issued by the last authenticated operator so long as the commands fall within the privileges granted. Even when a system attempts to predict outcomes of user actions, such systems are not fully integrated so as to anticipate future commands of a user and to consider a range of responses dependent on the level of the threat of the future commands.

A plan recognition system can be developed that increases the level of protection afforded against unauthorized entry and/or use by recognizing the goal or goals of an agent and by taking appropriate action. However, is also necessary to recognize when the agent has abandoned one or more goals.

If a plan recognition system is unable to recognize goal abandonment, the plan recognition system will build up an ever increasing set of active or open (pending) plans that the agent has no intention of completing. A system attempting to find completions for these open plans will wind up considering an unreasonable number of situations that will slow down the recognition of the goals not abandoned.

Existing plan recognition systems do not recognize goal abandonment. Instead, they have adopted a number of methods to work around this problem. For example, some systems consider only the goal that an agent is currently executing. Such a system discards previous goals of this agent (possibly remembering a history of past help). In domains like this, there is no need for a treatment of abandoned goals as any different than a simple change in the system's belief about the current goal of the agent. However in domains where the abandonment of a specific goal may require a response, this approach is unacceptable.

In some systems, there is often only one goal of concern—the user acquiring a skill or knowledge from the system. For these systems, only those actions that are part of the educational process are relevant for recognition. Behaviors not explainable in terms of the educational goal indicate that the agent's attention has wandered and that the system should attempt to refocus the agent on the learning task. However, such an assumption is too strong. In most real world applications, users will have a wide range of possible goals, many (if not all) of which can be abandoned without significant consequences.

In other systems, if is assumed that, while an agent may interrupt one goal in order to achieve another one, the agent will eventually return to the original goal. Again, this assumption is simply not true for many real world applications.

Still other systems expect that agents can be counted upon to communicate that they have abandoned a goal, possibly in response to a direct query from the system. However, such a requirement does place a significant load on the users. Further, it is not clear that users can be reasonably expected to honestly answer such a query. Not all users are cooperative.

The present invention in one embodiment is related to a probabilistic model for the recognition of goal abandonment.

### SUMMARY OF THE INVENTION

In accordance with one aspect of the present invention, a plan recognition method, implemented by a processing system, comprises the following: monitoring actions of a user; recognizing a plan of the user based on the monitored actions; and, recognizing an abandonment of the plan based on the monitored actions.

In accordance with another aspect of the present invention, a plan recognition method, implemented by a processing system, comprises the following: maintaining a model to provide an estimate of whether plans of a user are normal or hostile; monitoring actions of the user; recognizing the plans of the user based on the monitored actions; recognizing an abandonment of one or more of the plans based on the monitored actions; and, processing the model in light of any plans recognized as abandoned.

### BRIEF DESCRIPTION OF THE DRAWINGS

These and other features and advantages will become more apparent from a detailed consideration of the invention when taken in conjunction with the drawings in which:

FIG. 1 illustrates an exemplary plan recognition system in which the present invention may be used;

FIG. 2 illustrates a system providing an operating environment for the plan recognition system FIG. 1;

FIG. 3 illustrates an exemplary software architecture of the plan recognition system;

FIG. 4 is a diagrammatical illustration of an exemplary plan library useful in an in-home actor monitoring and response system environment.

FIG. 5 illustrates another example of a simplified plan library that can be used to predict possible plans of an agent intruding into a simplified computer network;

FIG. 6 illustrates the generation of pending sets of actions related to plans in the plan library;

FIG. 7 is a diagrammatical illustration of an exemplary execution trace generated by the plan recognition methodology implemented by the plan recognition module of FIG. 3;

FIG. 8 is a diagrammatical illustration of exemplary execution traces generated by the plan recognition methodology described herein;

FIGS. 9A-9G are diagrammatical illustrations of possible goal explanations generated by the plan recognition module of FIG. 3 in accordance with a hypothetical observed event;

FIG. 10 illustrates user models, session models, and/or cost models maintained by the threat assessment module of FIG. 3;

FIG. 11 provides an example of a session model maintained by the threat assessment module of FIG. 3;

FIG. 12 illustrates the generation of pending sets of actions related to plans in the plan library when plan abandonment is considered;

FIG. 13 is a diagrammatical illustration of an exemplary simple plan library useful in explaining recognition of plan/goal abandonment; and,

FIG. 14 is a graph showing the probability that an action does not contribute to a goal for three different sets of conditions.

### DETAILED DESCRIPTION

A plan recognition system such as that in which the present invention can be used performs an continuous evaluation of a user's right to continue to use an associated asset such as a computer system. By contrast, many existing security systems authenticate a user's right to access just once, at the beginning of a session. Hijacking such a session defeats this authentication.

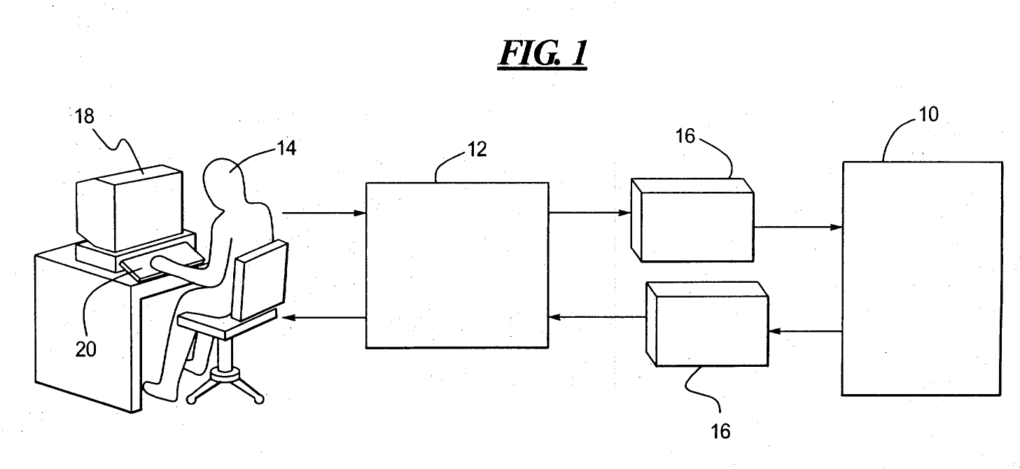

As shown in FIG. 1, an asset 10, such as a chemical plant, is safeguarded by a plan recognition system 12. The plan recognition system 12 stands between all external commands initiated by a user 14 and a control system 16 that regulates the asset 10. The user 14 interacts with the process via a user interface 18. As the user 14 presses buttons such as on a keyboard 20 or a mouse, the plan recognition system 12 makes a number of inquiries such as (i) what are the possible implications of the current command sequence being input by the user 14 with respect to plant safety, production, environment, property, etc., (ii) is the user 14 of the control system 16 a valid user, (iii) is the user 14 indisposed and is someone else is pressing the buttons, (iv) is the user 14 behaving erratically, and/or (v) are there others with the user 14?

Some of these questions may be dismissed easily. For example, the plan recognition system 12 may include a camera to monitor activity in a viewing area that includes the area in which the user 14 interacts with the interface 18, the keyboard 20, and/or a mouse. If the user 14 captured by the camera matches the official photograph of the valid user, and if the plan recognition system 12 determines that the typing pattern from the keyboard 20 and/or the pointing pattern relative to a pointing device such as mouse, a trackball, or a touch screen matches the one learned for the valid user, the plan recognition system 12 gains some confidence as to the authenticity of the user 14. However, positive answers to one or more of the skeptical questions listed above would lead to an elevated level of suspicion.

The plan recognition system 12 can be arranged to respond in a graded manner depending on the level of suspicion. For example, the plan recognition system 12 may (i) simply log a suspicion for later analysis, (ii) ask the user 14 whether the user 14 understands the possible consequences of a control action or a series of control actions undertaken by the user 14, (iii) require a greater level of authentication such as asking for a password, personal information, and/or a physical key device to be produced, acquiring biometric confirmation, or the like, (iv) notify others (operators, managers, engineers) of possible doubts that the plan recognition system 12 may have about the user 14 or about the control actions initiated by the user 14, (v) enable delays to prevent catastrophic changes, (vi) require confirmation from others before allowing the user 14 to proceed, and/or (vii) refuse to proceed such as by locking out the control console and taking automated steps to “park” the plant 10 in a safe operating region.

The plan recognition system 12 can incorporate multiple technologies. For example, the plan recognition system of the present invention can employ passive biometrics that identify the command issuer on a frequent basis without interrupting workflow. Such passive biometrics can include (i) face recognition identification, (ii) fingerprint identification, (iii) voice print identification, (iv) user-specific models that identify users according to their ideosynchratic input-device operation such as keystroke timing, pressure, and/or typical errors, and/or (v) stress detection through acoustic, visual and/or infrared sensing, etc.

The plan recognition system 12 can be arranged to recognize and track a user's plans or intent. Plan or intent recognition and tracking may include logging the commands of the user and using a library of known plans to infer hostile plans by the user. Thus, as the user enters each command, the plan recognition system 12 adds this command to the preceding commands to form command sequence, and compares this command sequence to the corresponding sequences of the plans stored in a plan library. If the command sequence matches the initial commands of a plan stored in the plan library, subsequent commands in the matching plan may then be inferred. The recognition of such a hostile plan would then allow an inference of intent on the part of the user, and permit steps to be taken in order to mitigate possibly damaging outcomes of the plan. Thus, plan recognition is inferring the goals of an agent from observations of that agent's actions.

Goldman, R. P., Geib, C. G., Miller C. W. (1999), in “A new model of plan recognition,” Proceedings of the 1999 Conference on Uncertainty in Artificial Intelligence, disclose probabilistic abductive plan recognition that is centered on plan execution and that addresses issues such as world state and context, multiple interleaved plans, partially ordered plans, and negative evidence (a lack of a report of an action.) This disclosure goes beyond the previous framework of Charniak and Goldman in “A Bayesian model of plan recognition,” Artificial Intelligence, Vol. 64, pp 53-79, (1993) who proposed the use of Bayesian inference to handle explanations of the same complexity but different likelihoods.

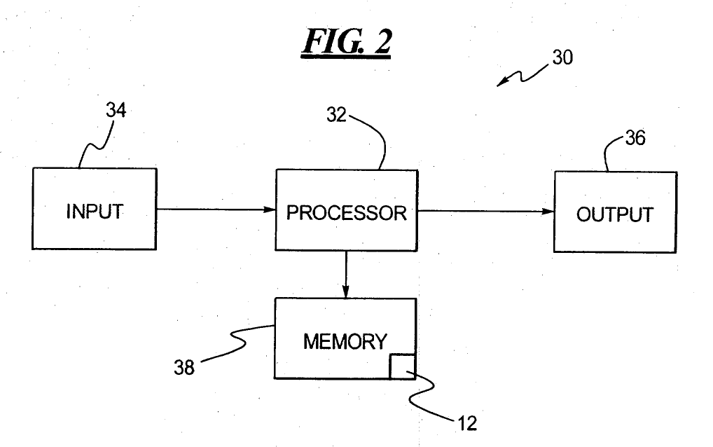

The plan recognition system 12 may be implemented by a system 30 such as that shown in FIG. 2. The system 30 includes a processor 32 that receives inputs from one or more input devices 34 and provides outputs to one or more output devices 36 based on programs and data stored in a memory 38. For example, the input devices 34 may include one or more of the following: the keyboard 20, a mouse, biometric and other sensing and measurement devices such as those discussed herein, etc. The output devices 36 may include one or more of the following: one or more printers, one or more monitors supporting the user interface 18, one or more actuators, one or more controllers such as the control system 16, etc. The memory 38 stores data and such programs as the plan recognition system 12. The memory 38 also stores the plan library discussed herein.

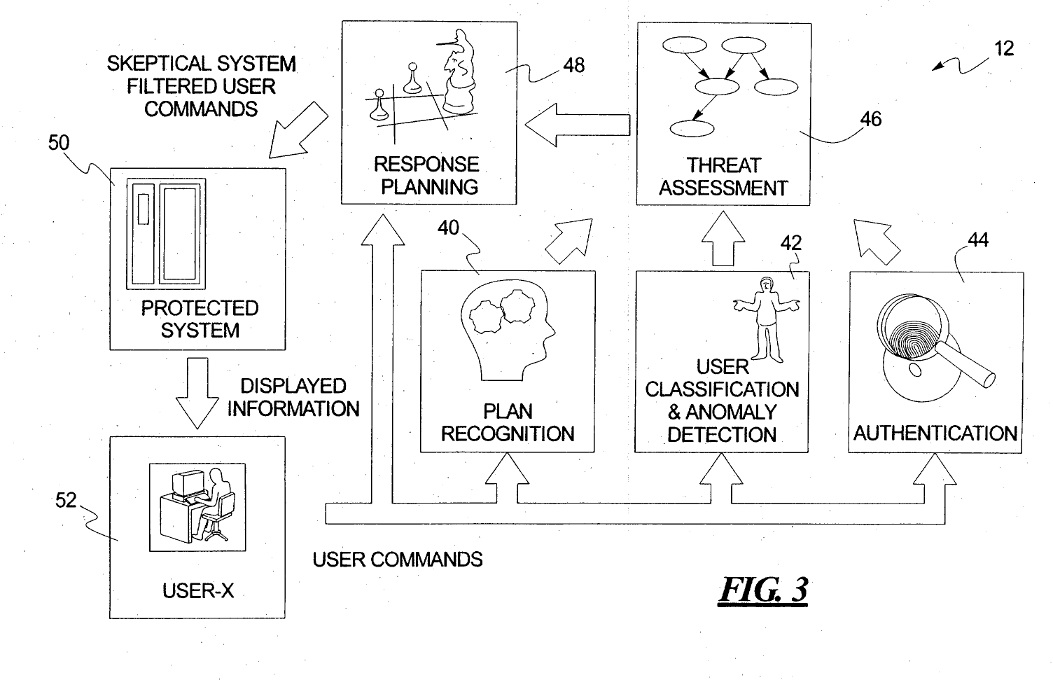

A software architecture comprising the plan recognition system 12 is shown in FIG. 3 and includes a plan recognition module 40, a user classification and anomaly detection module 42, an authentication module 44, a threat assessment module 46, and a response planning module 48. The plan recognition system 12 is used to protect such assets 50 as databases, computer networks, airplanes, weapon systems, automobiles, process control systems, security systems, environmental control systems, etc.

The plan recognition module 40 implements a plan recognition methodology in order to recognize and predict the plans of a user 52. Thus, the plan recognition module 40 continuously monitors the command inputs issued by the user 52. These command inputs indicate action sequences and state changes initiated by the user 52 or otherwise. Based at least partly on plans of the plan library stored in the memory 38, the plan recognition module 40 hypothesizes unobserved actions that have taken and/or will take place and that are consistent with the observed actions, the observed state changes, and the plans stored in the plan library. Accordingly, the plan recognition module 40 creates a set of possible execution traces such as by use of the plans in the plan library stored in the memory 38. This set of execution traces indicates a pending set of actions by the user 52 that have not as yet been observed but that are possible from the observed actions, the observed state changes, and the plans stored in the plan library. The plan recognition module 40 then determines a probability distribution pertinent to the actions in the set of pending actions. Finally, the plan recognition module 40 supplies these sets of pending actions and corresponding probabilities to the threat assessment module 46.

The plan recognition module 40 may incorporate simple hierarchical (task decomposition) plans, and may reference information in the plan library, observed actions, and hypothesized unobserved actions in order to recognize or evaluate the likelihood that the user is engaged in a particular plan otherwise described in the plan library.

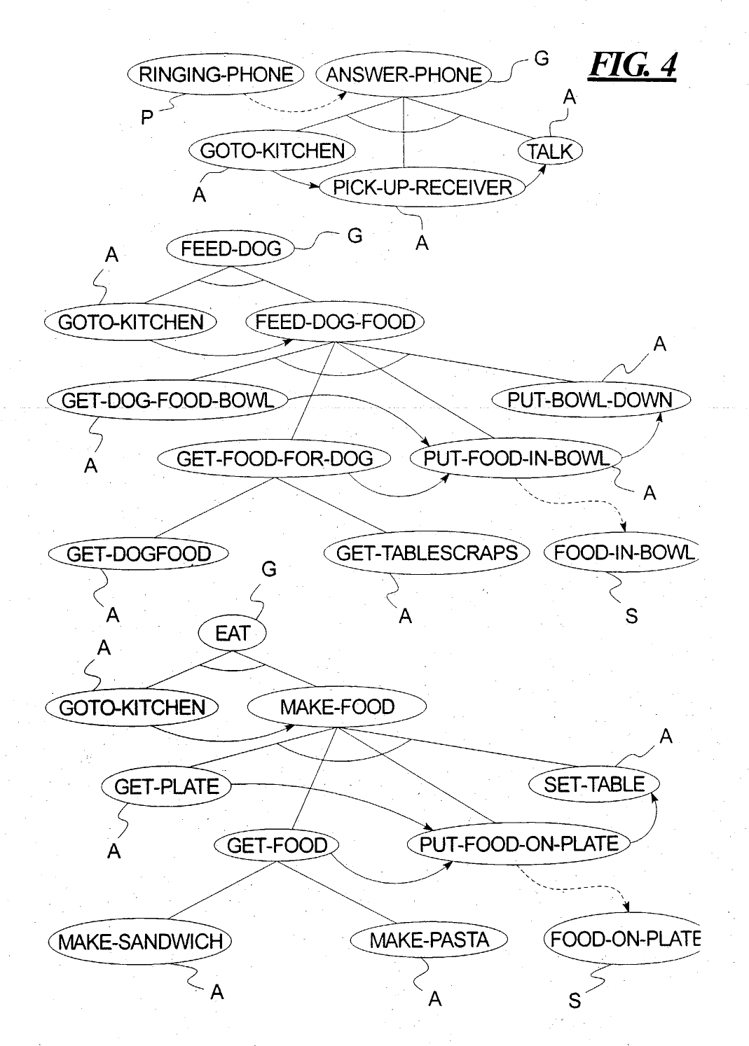

The plan library stores a listing of possible goals of the user 14, along-with “recipes” for achieving each of those goals. In particular, a sub-listing of at least one plan is provided for each goal. Within each plan, an activity plan graph is provided that consists of primitive actions required for completing the corresponding plan. In an embodiment of the present invention, each plan in the plan library may be viewed as an “and/or tree”. An example hierarchical plan library for an in-home actor domain is provided in diagrammatical form in FIG. 4. The plan library lists three possible root goals (referenced in FIG. 4 as “G”) of “Answer-phone,” “Feed-dog,” and “Eat.”

Each of the three trees defines a decomposition of the root goal into sequences of sub-actions that will achieve the root goal. With respect to the exemplary plan library of FIG. 4, such a decomposition is indicated by a straight solid line from the parent node to each of the children nodes. If all of the sub-actions must be done to achieve the parent goal, the parent goal is represented as an “and node” in the tree, and is illustrated in FIG. 4 by an arc crossing all of the links from the parent to the children. For example, the “Feed-dog-food” sub-goal requires that each of “Get-dog-food-bowl,” “Get-food-for-dog,” “Put-food-in-bowl” and “Put-bowl-down” occur for the sub-goal to be successfully achieved.

In many cases, the sub-steps of an “and node” must be done in a particular order. Ordering constraints between the actions are represented by directed arcs in the plan graph of FIG. 4. For example, in the “Answer-phone” plan definition, ordering constraints require that “Goto-kitchen” occur before “Pick-up-receiver,” and that “Pick-up-receiver” occur before “Talk.” Conversely, certain actions of a particular plan graph may not be ordered with respect to each other. For example, relative to the “Feed-dog” root goal, “Get-dog-food-bowl” or “Get-food-for-dog” can occur in any order, but both must occur before “Put-food-in-bowl”.

A goal or sub-goal can also be defined by a set of possible expansions, such that any single expansion can be executed to achieve the goal. In this case, the actor/agent executing the plan would naturally or purposefully “choose” exactly one of the expansions. Such choice points in the plan definitions are indicated by “or nodes”. With respect to the sample plan library of FIG. 4, an “or node” is illustrated by the absence of an “and arc” crossing the children's links to their parent node. For example, to achieve “Get-food-for-dog,” the agent/actor need (or must) only execute one of “Get-dog food” or “get-tablescraps.”

The definitions of plans are terminated in leaf nodes that represent “primitive actions” that are candidates for being observed in the domain (referenced in FIG. 4 as “A”).

Where applicable, a particular plan tree may further include a state precondition (“P” in FIG. 4; e.g., “Ringing-phone” is a state precondition for the “Answer-phone” root goal) and/or a state change or an effect of actions (“S” in FIG. 4; e.g., “Food-in-bowl” is a state change for the “Feed-dog” root goal, and “Food-on-plate” is a state change for the “Eat” root goal). Connection between a state precondition or a state change and the corresponding plan graph is represented by a broken line in FIG. 4.

It will be recognized that the plan library provided in FIG. 4 is but one example of limitless goals, plans, and plan graphs. Depending upon the complexity of the plan recognition system 12, the plan library can provide for countless possible goals each having multiple plans and extensive plan graphs. Contents of the plan library may be domain-specific, and the present invention is not limited to a daily living environment monitoring domain.

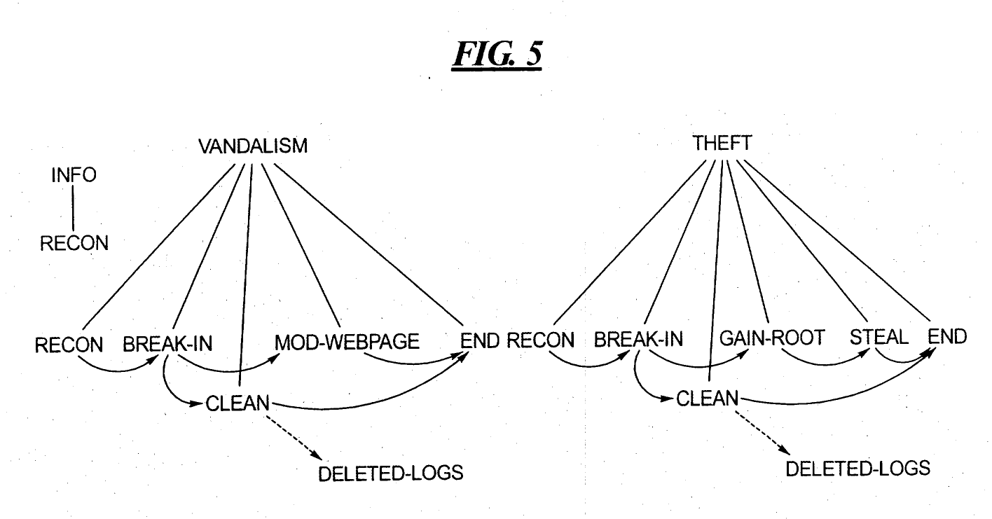

For example, the plan intent recognition 40 can be used in a computer security system domain and include information relating to goals such as stealing information from a computer or vandalizing web pages. An exemplary hierarchical plan library in diagrammatical form for a computer network security domain is provided in FIG. 5.

As shown in FIG. 5, if a hacker has a goal, such as stealing information from a computer (theft), the plan library breaks that goal into five steps: scan the system to determine vulnerabilities (recon); exploit the system's weaknesses to gain entry (break-in); escalate privileges (gain root); export desired data (steal); and, hide traces of the hacker's presence on the computer (clean). As before, ordering constraints within a plan of the plan library are represented by directed arcs. For example, the hacker must execute a break-in before privileges can be escalated (gain root).

It should be noted that there is a condition/event pairing that is tied to the action “clean.” The dashed line indicates this pairing and shows that a condition results from the execution of the action. Thus, if “clean” is an executed action, it will result in the condition of deleted event logs (deleted-logs). This information about action effects is necessary to infer the execution of unobserved actions.

Alternatively, the plan recognition module 40 can be used in-industrial control applications such as oil refineries, with the related plan library including goal/plan graph information specific to the industrial installation.

Regardless of the exact contents of the plan library, the plan recognition module 40 is adapted to utilize goal/plan information from the plan library in conjunction with observed actions of the user 14 and/or with inputs from the a user classification and anomaly detection module 42 and the authentication module 44 to generate a set of execution traces that provide a basis for probabilistically indicating the most likely goal of the user 14. One probabilistic-based technique for performing this analysis is provided below.

In general terms, the plan recognition module 40 generates and records an observed action stream based upon the observed actions of the actor and/or the actor's environment. The observed action stream provides a sequential listing of observed actions. The observed action stream is then compared against the plan library, and potentially corresponding plan graphs (and thus corresponding goals) are selected. The selected plan graphs are then used as the basis for generating a set of explanations that each include the observed action stream and at least a portion of the selected activity plan graph.

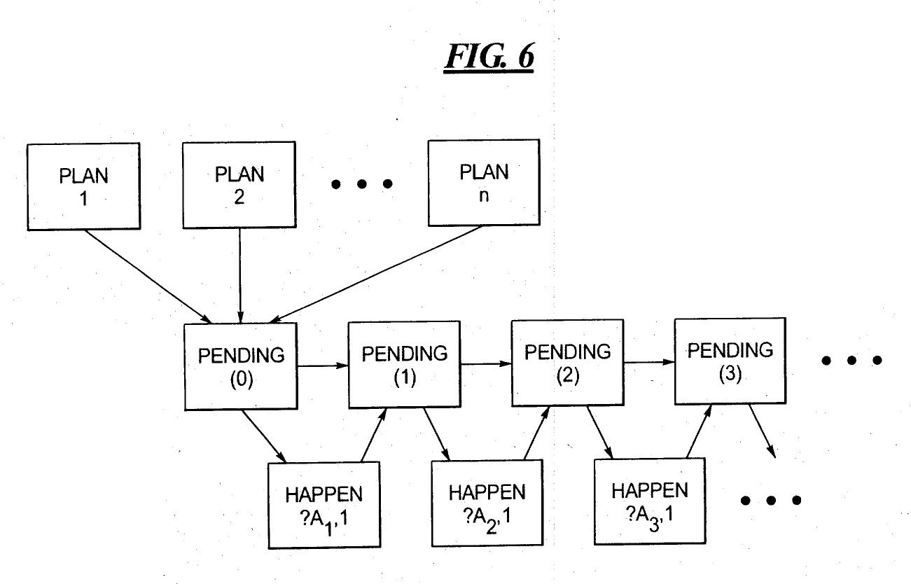

One preferred model of plan recognition is described in the aforementioned Goldman, R. P., Geib, C., and Miller, C., “A New Model of Plan Recognition,” Conference on Uncertainty in Artificial Intelligence, Stockhölm (July 1999), the teachings of which are incorporated herein by reference. In general terms, the preferred plan recognition model is based on the realization that plans are executed dynamically and that, at any given moment, the actor or agent is able to choose to execute any of the actions that have been enabled by the actor's or agent's previous actions. To formalize this slightly, initially the actor or agent has a set of goals and chooses a set of plans to execute to achieve these goals. The set of plans chosen determines the set of pending primitive actions. As the actor or agent continues engaging in a particular activity, the actor or agent will select and execute (sometimes repeatedly) one of the pending actions, thereby generating a new set of pending actions from which further actions will be chosen. The new pending set is generated from the previous set by removing the action just executed and adding newly enabled actions. Actions become enabled when their required predecessors are completed. This process is illustrated in FIG. 6. To provide some intuition for the probabilistically-inclined, the sequence of pending sets can be seen as a Markov chain.

The above view of plan execution provides a simple conceptual model for the generation of execution traces. To use this model to perform probabilistic plan recognition, a set of goals for the actor may be hypothesized, and the plan library may be utilized to engage in forward simulation of the actor's hypothesized goals. This process only considers simulations that are consistent with the observed actions in the order in which they are observed. As part of the simulation, the actor's pending sets are generated to determine if one or more of the goals in the plan library are consistent with actual observations of actions of the actor and/or the actor's environment. The resulting combination of an execution trace, with consistent pending set(s) and hypothesized goal(s), is referred to as an “explanation” of what the actor may be doing/intending to do.

The above process is repeated with each action, varying the hypothesized goals and how the observed actions contribute to those goals, in order to generate the complete and covering set of all possible explanations for the observed actions. Since this set of explanations for the observations is generated to be exclusive and exhaustive, a probability distribution can be established over the set. Based upon this probability distribution, an evaluation can be performed to determine which of the hypothesized possible goals the user 14 is most likely pursuing.

In accordance with one embodiment, computing the probability of a given root goal is a two-step process. First, the conditional probability of each explanation is established. Second, this conditional probability is used to compute the conditional probability of each of the root goals. In one implementation, the conditional probability of a specific explanation of a given set is determined by the following equation:

$$P ( {exp}_{1} \vert obs ) = {\prod }_{i = 1}^{I} P ( {root}_{i} ) \cdot {\prod }_{j = 1}^{J} ( \frac{1}{\vert {method}_{j} \vert} ) \cdot {\prod }_{k = 1}^{K} ( \frac{1}{\vert Pending {Set}_{k} \vert} ) \qquad ( 1 )$$

where:

exp₁=the specific explanation or execution trace;

obs=observed activity stream;

I=total number of goals/root intentions in exp₁;

rootᵢ=ith root goal/intent in exp₁;

P(rootᵢ)=prior probability of rootᵢ;

J=number of choices of “or nodes” in exp₁;

methodⱼ=jth choice/“or node” in exp₁;

|methodⱼ|=number of alternative possible expansions for methodⱼ;

K=|obs|;

Pending Setₖ=pending set at time k; and

|Pending Setₖ|=size of the pending set at time k.

The conditional probability for each root goal is generated by dividing the sum of the conditional probabilities of all the explanations that have the root goal by the sum of the conditional probabilities of all the explanations of the observations.

The above model is but one technique for probabilistically recognizing a plan or intent, and in no way limits the present invention.

Also, as described herein, the plan recognition module 40 may extend the probabilistic model, whatever its form, to account for unobserved actions as well.

Regardless of the exact technique by which the execution traces are generated, analyzed, or otherwise utilized for generating further information from which a probabilistic evaluation can be performed, the plan recognition module 40 has the ability to consider not only directly observed actions of the user 14 based on the user commands, but also potentially unobserved actions or events as part of the execution trace generating process. In particular, the plan recognition module 40 is adapted to introduce, and reason about, unobserved actions within a probabilistic framework. For example, relative to an in-home monitoring and response system domain, instances of a particular sensor malfunctioning or otherwise failing to detect a particular activity will undoubtedly occur from time-to-time. Were the execution traces limited to activity plan graphs (and thus related goals) that only exactly matched (in terms of required primitive actions) the observed action stream, a sensor malfunction could result in a failure by the plan recognition module 40 to consider the correct plan (and thus related goal) in which the user 14 was engaged. Simply stated, it is not sufficient to simply assume that the observed action stream is complete. The plan recognition module 40 overcomes this deficiency by constructing a set of possible execution traces, and by inserting hypothesized unobserved actions to complete them.

One implementation of this process is to again use the plan library to engage in forward simulation of the observation stream. However, rather than using the observation stream as the sole determiner of which actions are executed next, a choice point is added. Instead of only considering explanations that account for the next action in the observed stream, the plan recognition module 40 considers explanations in which any listed action in the associated pending set is hypothesized as possibly having been done but not observed. This methodology still requires that all actions in the observation stream eventually become part of the explanation being considered. However, hypothesized, unobserved actions that are consistent with the pending set can be “inserted” into the explanation being considered. It is recognized that, in theory, unbounded insertion of hypothesized unobserved actions will result in a significant expansion of the space of possible or considered explanations. However, the plan recognition module 40 addresses this potential issue as described below.

With respect to the probabilistic intent recognition model described above, the generation of explanations that include unobserved actions entails determining the conditional probability of the explanations. As such, an additional term is added to the first equation to produce the following equation:

$$P ( {exp}_{1} \vert obs ) = {\prod }_{i = 1}^{I} P ( {root}_{i} ) \cdot {\prod }_{j = 1}^{J} ( \frac{1}{\vert {method}_{j} \vert} ) \cdot {\prod }_{k = 1}^{K} ( \frac{1}{\vert Pending {Set}_{k} \vert} ) \cdot {\prod }_{l = 1}^{L} P ( {unob}_{l} ) \qquad ( 2 )$$

where:

exp₁=the specific explanation or execution trace;

obs observed activity stream;

I=total number of goals/root intentions in exp₁;

rootᵢ=ith root goal/intent in exp₁;f

P(rootᵢ)=prior probability of rootᵢ;

J=number of choices of “or nodes” in exp₁;

methodⱼ=jth choice/“or node” in exp₁;

|methodⱼ|=number of alternative possible expansions for methodⱼ;

K=|number of actions (observed and unobserved) in the explanation|;

|Pending Setₖ|=size of the pending set at time k;

L=number unobserved primitive actions in exp₁;

unob₁=1th unobserved leaf node or primitive action; and

P(unob₁)=prior probability that unob₁ is executed and is not observed.

The methodology disclosed herein is preferably further adapted to include guidelines for terminating the consideration process. As a point of reference, probabilistic intent recognition algorithms or models that do not otherwise account for unobserved actions will “terminate” when the complete set of observations are explained. Since the plan recognition module 40 adds unobserved actions, this termination criterion is not sufficient. Instead, the methodology disclosed herein determines the likelihood that various actions have been executed and were not observed in order to evaluate when to stop adding hypothesized unobserved actions to a proposed execution trace. In this regard, not all actions are equally likely to be executed without detection. Some actions are harder to hide than others. For example, the probability that a person could make a small change in the amount of air entering into a home undetected is much higher than the probability that the person could successfully turn off the entire HVAC system of the home unnoticed. By capturing the probability that an action can be executed without observation, it is possible for the plan recognition module 40 to generate the probability of a sequence of actions being executed unobserved. In addition, the methodology disclosed herein bounds the probability of the unobserved actions with an explanation that the actor or user (or others associated with installation and operation of the plan recognition module 40) are willing to accept.

If no threshold were placed on the likelihood of unobserved actions, the process of inferring actions would proceed to successively more and more unlikely explanations by adding more and more unobserved actions. To prevent the generation of this infinite sequence of ever less likely explanations of the actor's intent/goal (via resultant execution traces), the plan recognition module 40 may be arranged to require a threshold probability value for the unobserved actions. The execution traces are then constructed as previously described. For any execution trace including at least one hypothesized unobserved action, the likelihood of that unobserved action(s) being executed unnoticed is determined. If this determined likelihood is less than the pre-determined threshold value, the execution trace is eliminated from further consideration. In effect, the plan recognition module 40 allows the user (or others) to specify how unlikely an explanation they are willing to accept, and then use this bound to limit the unobserved actions that are added to the execution trace. Alternatively, a more straightforward fixed or known upper bound on the number of unobserved actions that can be inserted into any particular execution trace can be provided.

In order to bound the unobserved actions, the last term of the second equation is critical, and a running total is maintained for this term. Given the probability threshold value (T) (selected and entered by the user), and an acceptable execution trace, the hypothesized execution trace must satisfy the following inequality:

$$T \leq {\prod }_{l = 1}^{L} P ( {unob}_{l} ) if L > 0 \qquad ( 3 )$$

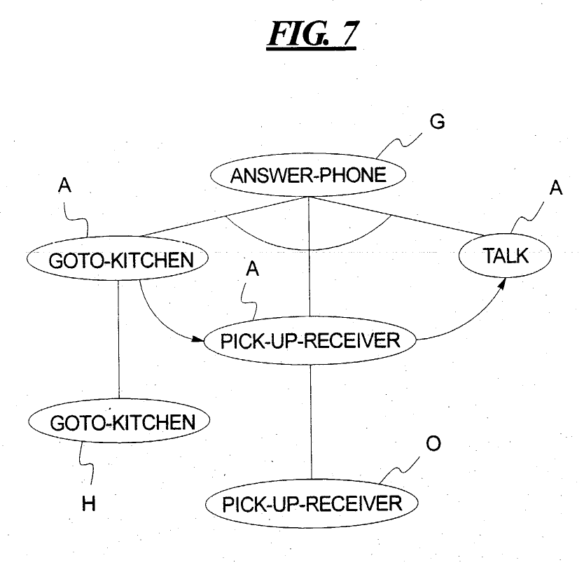

To better illustrate the effect of considering unobserved actions, reference is made to the plan library of FIG. 4. Relative to this plan library, where an observed action stream is found to be [“Pick-up-receiver”], if unobserved actions were not accounted for, the “Answer-phone goal” would not be considered (nor would the “Feed-dog” or the “Eat” goals) since the observed action stream does not include “Goto-kitchen”. However, by hypothesizing that “Goto-kitchen” was unobserved and inserting it into the corresponding execution trace (e.g., [“Goto-kitchen”, “Pick-up-receiver”]), the “Answer-phone” goal would be considered as part of the probabilistic plan evaluation. This relationship is shown diagrammatically in FIG. 7, with the observed event of “Pick-up-receiver” designated by “O” and the hypothesized, unobserved event of “Goto-kitchen” denoted as “H”.

Although the above example is highly simplistic, it is recognized that simply assuming that every possible action was unobserved will significantly expand the search space. The plan recognition module 40 prunes this space through ordering constraints provided by the observations. In particular, if a plan, graph (possibly containing more than a single root goal and associated plans), does not contain all of the observed actions of the observed action stream, or if the observed action stream does not obey the ordering constraints imposed by the plan graph, that particular plan graph can be filtered from consideration and not be used as a basis for an execution trace.

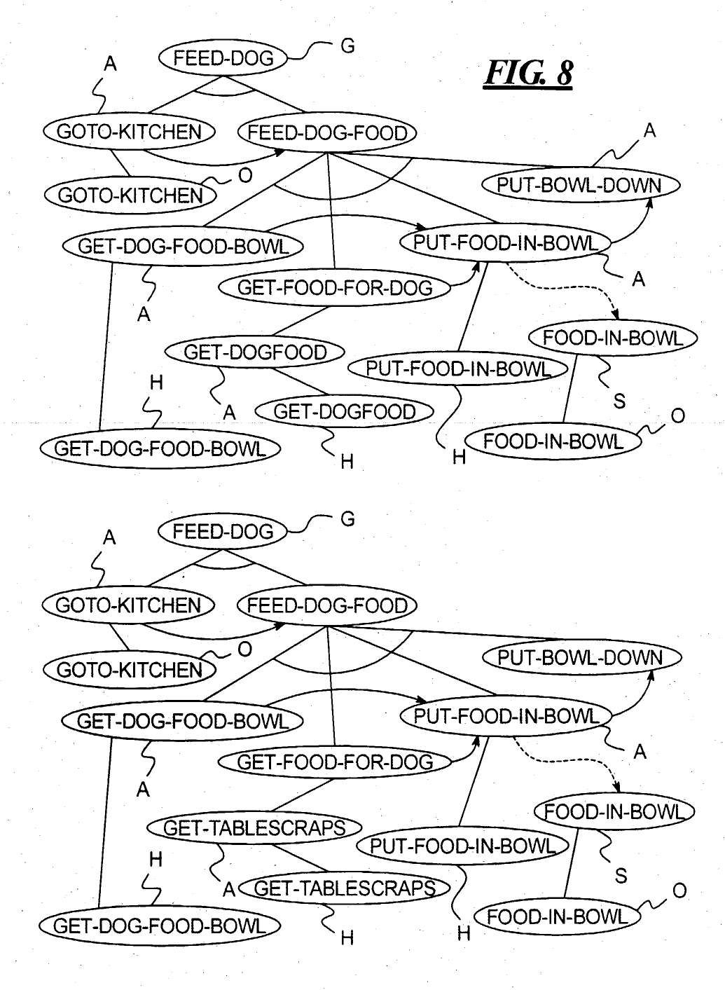

Additionally, unobserved actions can be inferred from state changes. In particular, while a particular sensor of the control system 16 may fail to detect performance of an action, the resulting effects of that action can still be “observed, by other sensors of the control system 16. Thus, a reported state change can provide evidence, or otherwise indicate occurrence, of unobserved action(s) that would give rise to the reported desired effect. From them, it can be inferred that the action must have occurred before the report of the state change. Reports of a state change can also simply provide confirming information about a previously observed action. For example, and referring to the plan library of FIG. 4, consider an observed action stream of [“Goto-kitchen”, “Food-in-bowl”]. A report of “Food-in-bowl” (or state change) implies that “Put-food-in-bowl”, “Get-dog-food-bowl”, and one of “Get-dog-food” or “Get-tablescraps” have occurred unobserved. Further, the ordering constraints in the plan library imply that they must fall between execution of “Goto-kitchen” and “Food-in-bowl”. Thus, state change reports give more information about the execution traces that are consistent with the observation. As a point of further explanation, FIG. 8 illustrates in diagrammatical form the possible execution traces resulting from the above example, with observed actions being denoted as “O” and inserted, hypothesized unobserved actions identified as “H”.

In an embodiment of the present invention, the plan recognition module 40 is adapted to perform the state change processing based upon an assumption that there is only a single report for a given state change. This feature obviates potential processing complications whereby multiple sensors each reporting the same state change will not cause the plan recognition module 40 to believe that the given proposition has changed state more than once. Essentially, “chattering” sensors that would otherwise produce multiple reports of the same state change are filtered.

In addition, the possible execution traces that otherwise include at least one hypothesized unobserved action are also filtered to be consistent with the unobserved actions that are implied by unenabled actions. In this regard, an “unenabled action” is an observed action whose enabling actions, i.e., the actions that must come before it according to the plan library, were not first observed. For example, considering again the plan library provided in FIG. 4, and in particular the “Feed-dog” and “Eat” root goals, where an observed action stream of [“Get-dog food”, “Make-sandwich”] is observed, it can be concluded that these actions are members of disjoint plans; that is, no single root goal will explain both of these actions. However, these actions are even more informative since they are both unenabled by the observed actions. With respect to this hypothetical observed action stream, the plan library of FIG. 4 specifies that “Goto-kitchen” must occur before “Get-dog-food” and “Make-sandwich”. Therefore, in order to explain these two observations, it can be hypothesized that “Goto-kitchen” has been executed unobserved. Thus, these two actions provide evidence of two distinct plans: [“Goto-kitchen”, “Get-dog-food”] and [“Goto-kitchen”, “Make-sandwich”].

Unenabled actions provide more information for use in reconstructing the actor's actual actions than other observations. They require that the action itself be in the sequence, but they also provide evidence of unobserved actions. Relative to the generation of execution traces based upon the above example, the set of observations can allow pruning of any execution sequence or trace that does not contain “Get-dog-food”, followed sometime later by an “Make-sandwich”, but it also dictates that any execution trace that does not have “Goto-kitchen” preceding “Get-dog-food” should be ignored. These unenabled actions are very important pieces of information when attempting to infer the plans of the actor.

The above described algorithm for probabilistically accounting for unobserved actions in the context of automated intent or goal recognition overcomes problems identified with previous intent recognition methodologies. The execution traces generated by the plan recognition module 40 can be analyzed in a number of different manners (one specific example of which is provided below). However, considering hypothesized unobserved actions as a part of the execution trace generation process, and in conjunction with the threshold bound, will allow the plan recognition module 40 to handle domains that are otherwise too complex for existing methodologies.

As previously described, the set of execution traces generated by the above algorithm (that otherwise were probabilistically deemed acceptable), includes one or more hypothesized unobserved actions, and are utilized by the plan recognition module 40 to probabilistically recognize or estimate an intention or goal of the actor or agent depending upon the particular domain application.

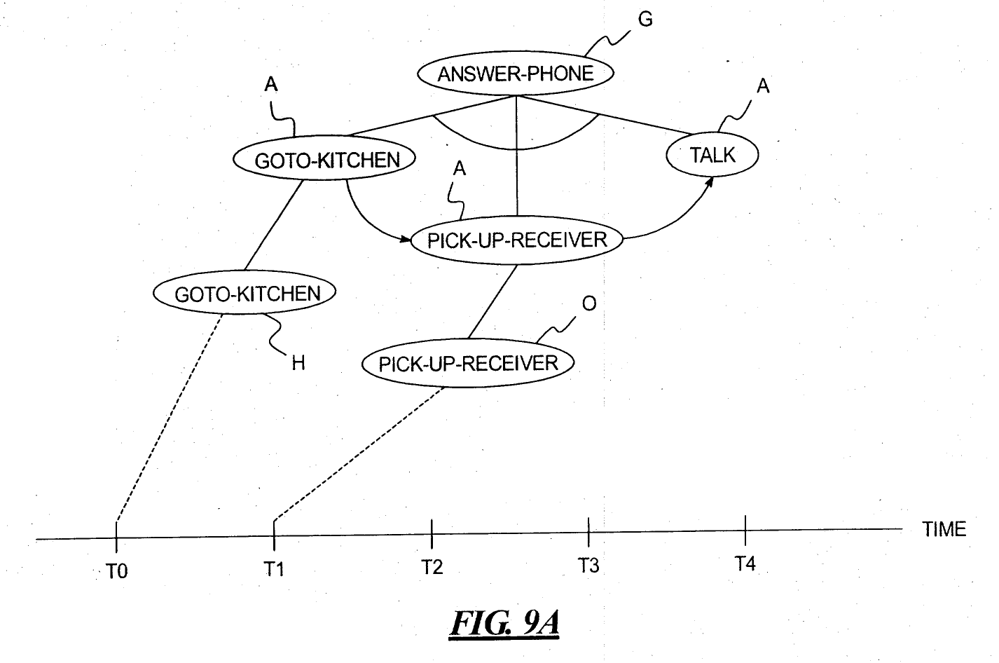

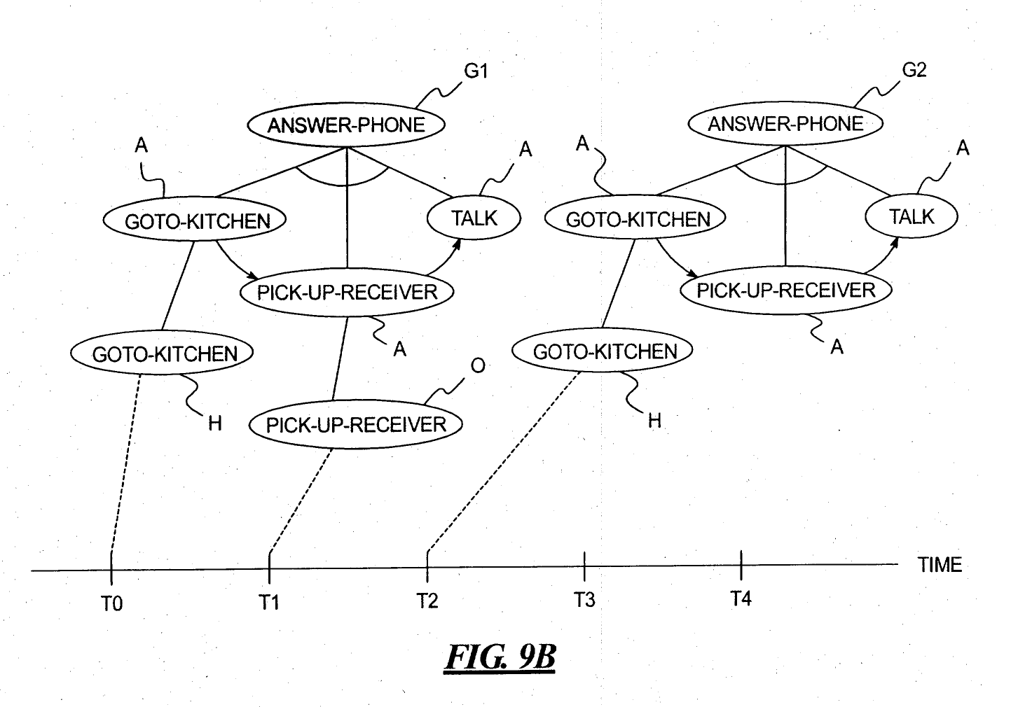

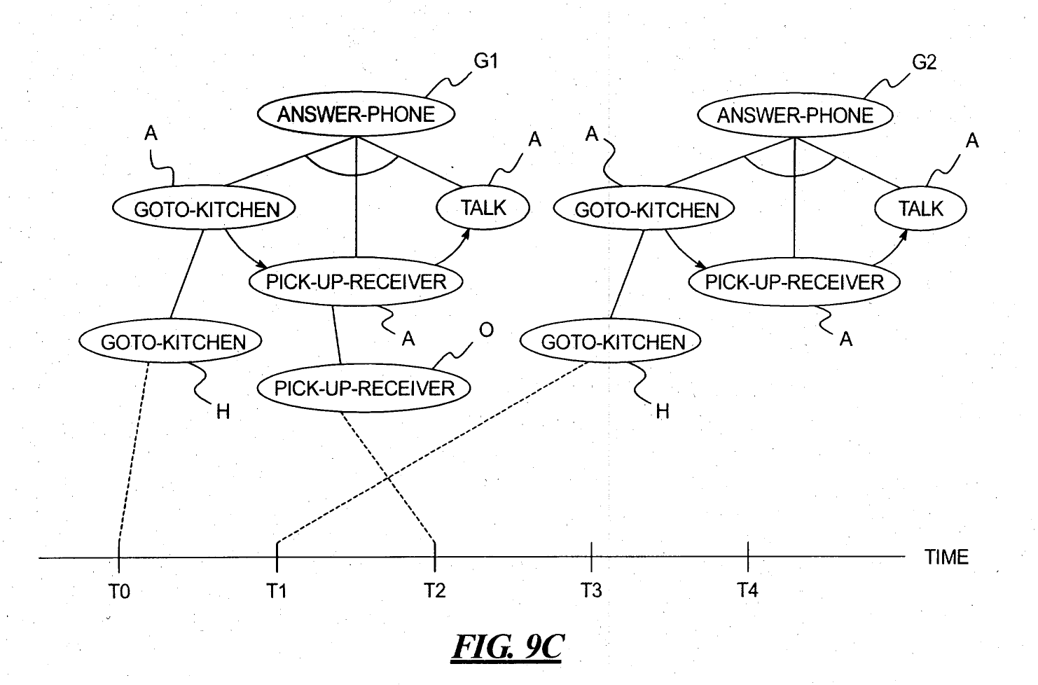

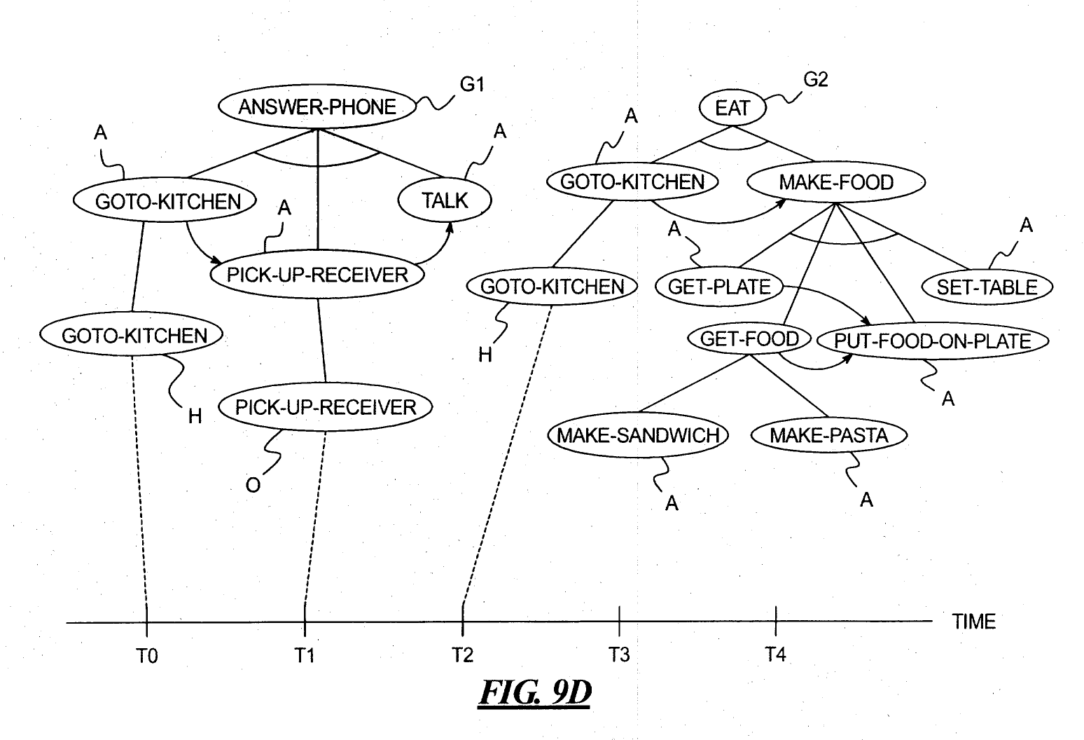

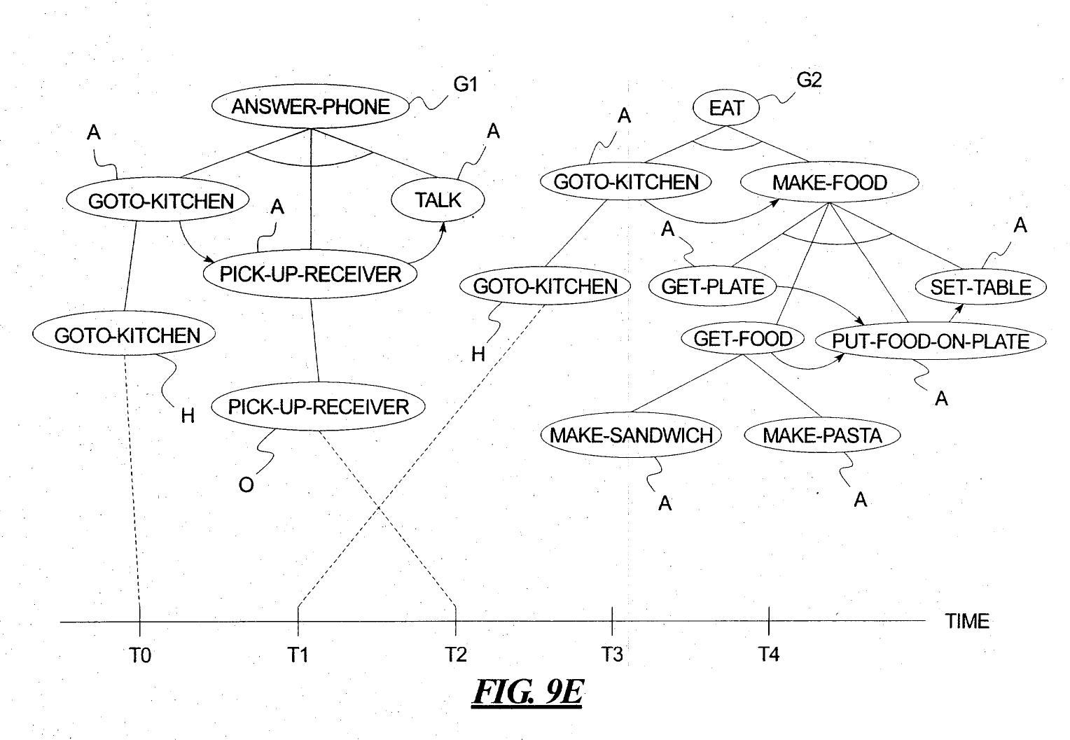

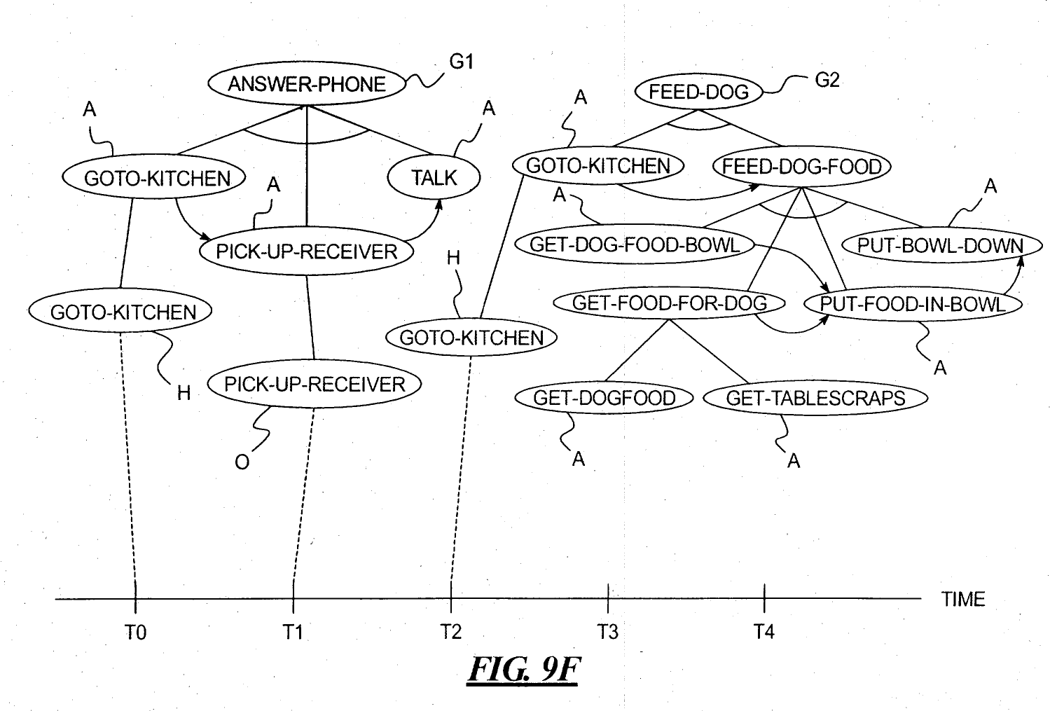

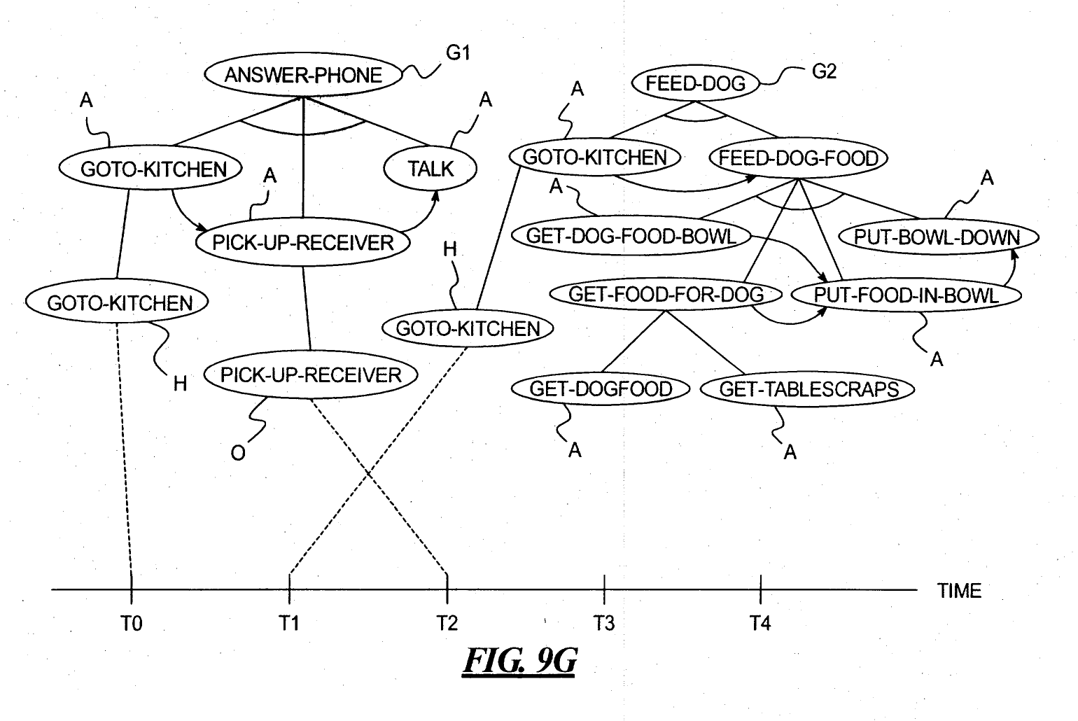

With continued reference to the plan library of FIG. 4, a hypothetical observation stream may consist of a single [“Pick-up-receiver”] event. Assuming a set threshold limit sufficient to allow two unobserved “Goto-Kitchen” events but no others, the single “Pick-up-receiver” observation would result in seven possible explanations or execution traces, shown diagrammatically in FIGS. 9A-9G. FIG. 9A illustrates a first possible explanation of a single “Answer-phone” goal dictated by “Goto-kitchen” being unobserved at time T0 followed by the observed “Pick-up-receiver” at time T1. FIG. 9B illustrates a second possible explanation characterized by two “Answer-phone” goals, one (“G1”) dictated by “Goto-kitchen” unobserved at time T0 followed by the observed “Pick-up-receiver” at time T1; the other “Answer-phone” goal (“G2”) dictated by a hypothesized, unobserved “Goto-kitchen” at time T2. FIG. 9C illustrates a third possible explanation again characterized by two “Answer-phone” goals. However, unlike the second possible explanation, the first goal (“G1”) of the third possible explanation are supported by “Goto-kitchen” being unobserved at time T0 and the observed “Pick-up-receiver” at time T2; the other “Answer-phone goal (“G2”) is supported by “Goto-kitchen” observed at time T1.

A fourth possible explanation, characterized by one “Answer-phone” goal (“G1”) and one “Eat” goal (“G2”), is shown in FIG. 9D. The “Answer-phone” goal is supported by the unobserved “Goto-kitchen” at time T0 followed by the observed “Pick-up-receiver” at time T1; the “Eat” goal is dictated by hypothesizing that “Goto-kitchen” was unobserved at time T2. A fifth explanation, illustrated in FIG. 9E, is similar to the explanation of FIG. 9D in that it includes an “Answer-phone” goal (“G1”) and an “Eat” goal (“G2”). However, the ordering of unobserved actions varies (accounting for the possibility that the actor may decide to eat before answering the phone). In particular, the “Answer-phone” goal of FIG. 9E is supported by “Goto-kitchen” unobserved at time T0 and the observed “Pick-up-receiver” at time T2; the “Eat” goal is supported by hypothesizing that “Goto-kitchen” occurred unobserved at time T1.

FIG. 9F illustrates a sixth possible explanation that includes the goals of “Answer-phone” (“G1”) and “Feed-dog” (“G2”). The “Answer-phone” goal is explained by hypothesizing that “Goto-kitchen” was observed at time T0 followed by the observed “Pick-up-receiver” at time T1; the “Feed-dog” goal is supported by hypothesizing that “Goto-kitchen” was unobserved at time T2. Conversely, the ordering of the “Answer-phone” and “Feed-dog” goals can be reversed, as reflected in the seventh possible explanation of FIG. 7G. In particular, the “Answer-phone” goal (“G1”) is supported by hypothesizing an unobserved occurrence of “Goto-kitchen” at time T0 followed by the observed “Pick-up-receiver” event at time T2; the “Feed-dog” goal (“G2”) of the seventh explanation is supported by hypothesizing an unobserved “Goto-kitchen” event at time T1.

It will be recognized that the above-described probabilistic methodology for recognizing a goal of an actor is but one available technique. Other probabilistic-based frameworks can also be applied. Regardless of the exact approach, however, the plan recognition module 40 incorporates the ability to extend the observed sequence of actions with hypothesized unobserved actions consistent with the observed actions, observed state changes, and the plan graphs to create a set of possible execution traces.

The resulting execution traces are then used as the basis for the probabilistic evaluation, such as that described above (e.g., the set of execution traces are used to construct pending sets and then the probability distribution over the sets of hypotheses of goals and plans implicated by each of the traces and pending sets). The resulting information generated by the plan recognition module 40 can then be used by or with the threat assessment module 46 in evaluating the current situation and needs of the user 14, as well as to formulate appropriate responses in conjunction with the response planning module 48.

To summarize, hostile agents can be handled by extending the observed sequence of actions with hypothesized unobserved actions consistent with the observed actions, the observed state changes, and the plan graph in order to create a set of possible execution traces. The set of execution traces are used to construct the pending sets, and then the probability distribution over the sets of hypotheses of goals and plans implicated by each of the traces and pending sets is produced.

In the implementation of the plan recognition algorithm as described above, it has been assumed that the given observations are true and correctly ordered. This assumption means as discussed above that the observed actions happened and in the order indicated by the sequence. Thus, if there is a sequence of three observations, recon, break-in, and gain-root, it is known that recon happened before break-in which happened before gain-root. The observation sequences are not assumed to be complete. Therefore, it cannot be concluded that clean did not happen between break-in and gain-root, or even after gain-root. However, ordering constraints provided by the plan library allow some possibilities to be ruled out. For example, the ordering constraints allow the conclusion that, if clean did occur unobserved, it could not have occurred before the break-in unless there were an earlier unobserved break-in.

This assumption means that the validity of observations need not be questioned. However, in environments with hostile agents, this assumption should not be made. Consider a military example. If there is a report of troops massing at a particular location, the validity of the report must first be determined before considering the effect that this action would have on an assessment of the enemy's goals. It is, however, straightforward to complicate the model by including a traditional model of noisy observations.

As yet another example, the plan recognition system can be arranged to reason about how a protected asset will respond to user commands. Also, the plan recognition system should implement a response to any of the above that is commensurate with the changing security situation. The responses of a plan recognition system should preferably include hedging, they should preferably include slack to account for uncertainty, and they should preferably weigh the worst case of an intelligent adversary attempting to counter them.

The user classification and anomaly detection module 42 continuously monitors the user actions in order to identify and classify the user 52 based on a learned pattern of actions characterizing the user 52 and based on anomalies in the way the user 52 uses the protected asset. As discussed above, users have typing and pointing styles that involve such characteristics as typing rate, typing rhythm, typing errors, click rate, click rhythm, click errors etc. Also as discussed above, users have certain patterns of interaction with computers (such as the order in which applications are usually accessed) that the user classification and anomaly detection module 42 can learn and associate with the corresponding users. The user classification and anomaly detection module 42 uses these and other patterns and anomalies in order to identify and classify the user 52 and supplies this information to the threat assessment module 46.

The user classification and anomaly detection module 42 may implement statistical techniques in characterizing and identifying the user 52. Thus, the user classification and anomaly detection module 42 can maintain a continuously updated probability distribution over the space of known users during a session. Because the actions of the user 52 may apply unequally to the learned characteristics of plural users, the user classification and anomaly detection module 42 can assign a probability that the user 52 is each of the users stored in a user library of the memory 38. The user classification and anomaly detection module 42, therefore, supplies both the identifications and the corresponding probabilities to the threat assessment module 46. The threat assessment module 46 can combine this information with information from the authentication module 44 in making a more positive identification. Alternatively, only the identification of the user having the highest probability need be supplied to the threat assessment module 46. The user classification and anomaly detection module 42 can also supply information to the effect that the user 52 is not a known user, i.e., a user stored in a user library.

The authentication module 44 implements passive biometrics to identify the user 52 and supplies this identification to the threat assessment module 46. As discussed above, such passive biometrics, for example, can include face recognition identification, fingerprint identification, voice recognition identification, and/or stress detection through acoustic, visual and/or infrared sensing. Passive biometrics may also include retina and/or iris scans. Additionally or alternatively, active recognition may be employed by the authentication module 44. For example, the authentication module 44 may direct the user 52 to enter a pass word, a personal identification number, personal information, a fingerprint through use of a peripheral device, a signature, hand geometry, etc. Such direction may be random, periodic, and/or directed by the plan recognition system 12 such as when the plan recognition system 12 determines that the user 52 is suspicious.

One of the reasons to rely on both the user classification and anomaly detection module 42 and the authentication module 44 is to increase the probability of identifying the user 52. An agent with hostile intent can either coerce an authorized user to enter the authorized user's correct identity or use artificial means to trick the authentication module 44 into -believing that the authorized user is entering commands when, in fact, it is the hostile agent.

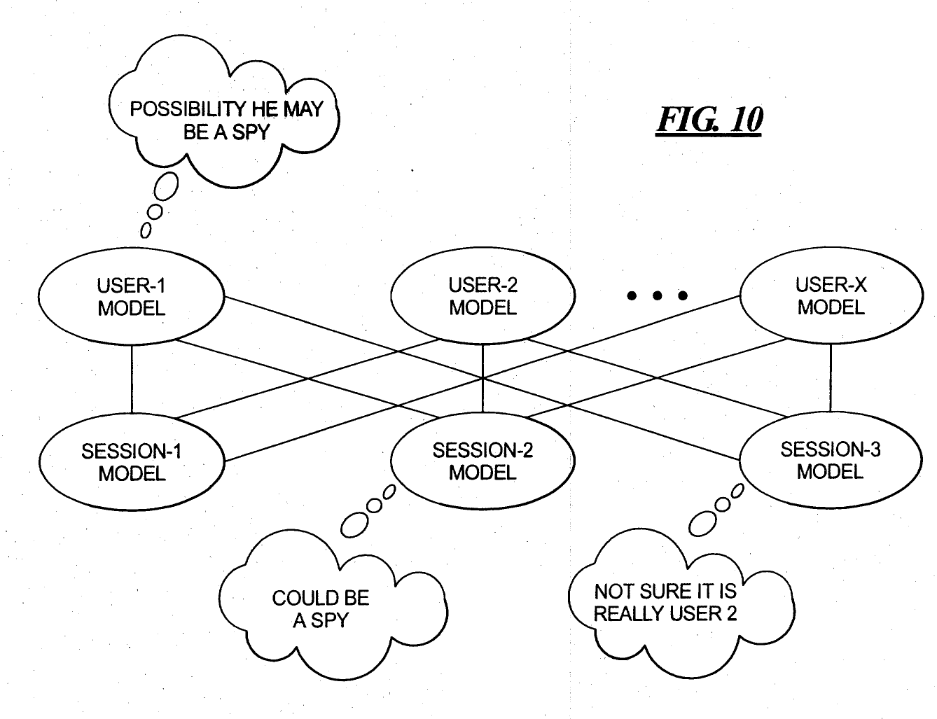

As shown in FIG. 10, the threat assessment module 46 uses the plan predicted by the plan recognition module 40, the identity and/or classification of the user 52 from the user classification and anomaly detection module 42, and the identification from the authentication module 44 in order to create user models, session models, and/or cost models.

The user models establish the odds that a given user has a particular primary motivation such as authorized use, spying, sabotage, etc. The user models may also act as placeholders for unknown users who may be present. Further, the user models are maintained over sessions. In other words, the user models are maintained permanently and/or semi-permanently, and are updated during each session.

The session models provide estimates of whether the plans of the user are normal or hostile. The threat assessment module 46 may render each session model as a Bayesian belief network. Session models relate one or more users in a probabilistic fashion because the identity of a user may not be known with certainty due to the possibility of spoofing by a knowledgeable insider that cannot be dismissed without continuous intrusive authentication. The threat assessment module 46 may be arranged to use the session models to periodically update the user models. That is, a session that is seen as spying may make a particular user more likely to be suspected of being a spy.

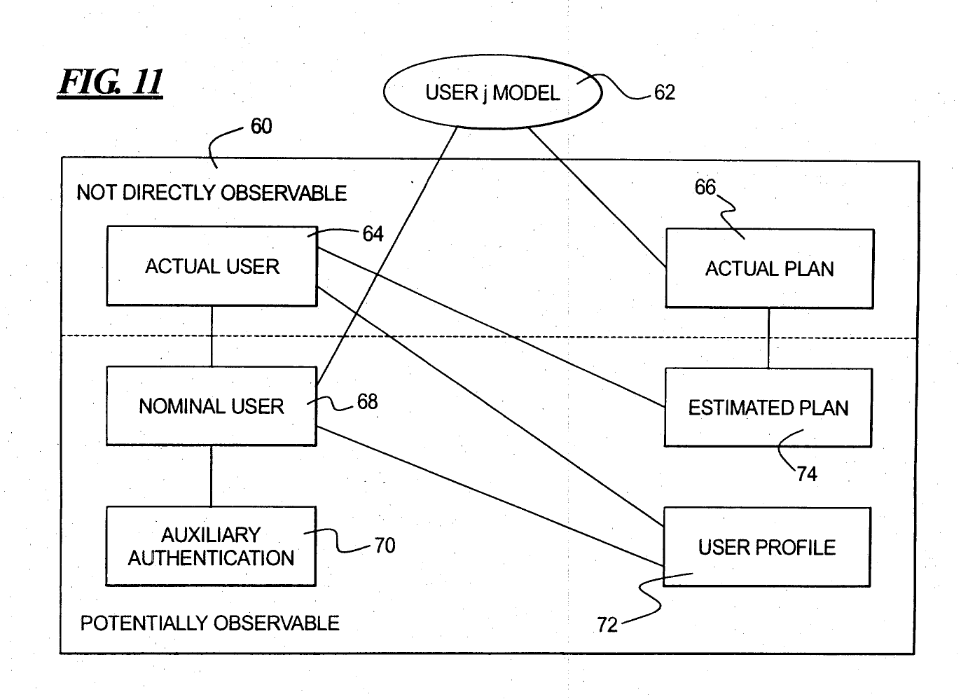

FIG. 11 provides an example of a session model 60 that is associated with a user model 62 for user j. The session model 60 is an example of a Bayesian belief network. The actual user 64 and the actual plan 66 are assumed to be not directly observable and, therefore, must be inferred. However, the session model 60 for session i maintained by the threat assessment module 46 can observe a nominal user identity 68 as provided by the authentication module 44 and as supported by an auxiliary authentication 70 provided by an auxiliary system and as supported by a user profile 72 provided by the user classification and anomaly detection module 42. The auxiliary authentication 70 may use biometrics, a token in the possession of the user, or on some shared secret or other knowledge in the user's possession to support identification of a user, whereas primary authentication is based on a password. The threat assessment module 46 for the session 60 may infer the actual user 64 from the nominal user identity 68 and from a predicted plan 74 provided by the plan recognition module 40. Moreover, the threat assessment module 46 may infer the actual plan 66 from the predicted plan 74 provided by the plan recognition module 40.

The cost model is useful in determining an appropriate response to the threat as assessed by the threat assessment module 46. The cost model is a model of the cost that is likely to result from the intended plan predicted by the plan recognition module 40. Costs may be stored in the memory 38 for each of the plans stored in the plan library and may be accessed from the memory 38 based on the intended plan provided by the plan recognition module 40.

The threat assessment module 46 determines the threat dependent upon the user identity, the estimated plan, and the cost associated with the estimated plan. For example, the memory 38 may store threat assessments as a function of the estimated plan, the cost resulting from execution of the plan, and the class of and/or identity of the user currently issuing commands. The threat assessment module 46 then accesses a particular one of the stored threat assessments using the estimated plan, the cost resulting from execution of the plan, and the class of and/or identity of the user currently issuing commands as an address into the memory 38 and passes its threat assessment to the response planning module 48.

The response planning module 48 maintains a response model that models the likely effectiveness of various responses to the threat assessments provided by the threat assessment module 46. The following are responses that can be implemented by the response planning module 48 based on the threat assessment from the threat assessment module 46. The commands of the user 52 can be simply passed to the protected assets 50 because there is no substantial threat (PASS). The commands of the user 52 can be logged for later supervisory review because the threat is low (LOG). The commands of the user 52 can be delayed which is a useful strategy in some denial-of-service (DoS) situations such as where hackers attempt to deny users service by overloading the Internet or a web site (DELAY). The user 52 may be required to re-submit proof in order to authenticate the user's identity (AUTHENTICATE). The user 52 may be asked if the user 52 intends the effect that the commands of the user 52 are likely to have (VERIFY). Corroboration of the commands may be required from another party before the commands are implemented (CORROBORATE). The commands of the user 52 may be implemented but a backup of data or other information may be maintained for later restoration in case the commands prove to be improper (HEDGE). The user 52 may be tricked into believing that the commands have been implemented when, in fact, they have not (SPOOF). The commands of the user 52 can be simply rejected (REJECT). The current session can be simply terminated (TERMINATE). Moreover, combinations of these responses can also be implemented. These responses are stored and are accessed dependent upon the threat assessment received from the threat assessment module 46.

Accordingly, the plan recognition system 12 acts as a filter on the commands of the user 52 and maintains a skepticism about the user 52 and the commands of the user 52.

As described above, the plan recognition system 12 continuously monitors the authenticity of the user 52 and of the commands issued by the user 52. This continuous monitoring means asking whether the issuer of a command is really the entity it claims to be. The plan recognition system 12 continuously evaluates the likely consequences of the commands it receives. Accordingly, the plan recognition system 12 envisions the consequences of commands and assesses losses should those consequences occur. The plan recognition system 12 continuously evaluates the probable intentions behind the commands it receives. Although intent recognition is difficult to achieve generally, certain normal and abnormal patterns of commands can strongly indicate either benign or malign intent. The plan recognition system 12 actively intervenes only when safety, significant economic losses, and/or environmental jeopardy warrants intervention. The responses of the plan recognition system 12 to user commands are conditioned by its best estimate of authenticity, integrity, consequences, and intent and are accordingly implemented in a graded manner. There is a spectrum of possible responses possible, from instant compliance to counter action. The plan recognition system 12 preferably conceals its suspicions from doubted agents where revelation runs a risk of being exploited. Providing too much feedback can both be a distraction and allow the system to be more easily fooled.

The plan recognition system 12 should be tamperproof. There should be no way for an attacker to subvert or sidestep the skeptical mechanisms. No artifact is impervious from tampering, but the threshold for attacks of this sort must be set high enough to make it very unattractive. The authority of the plan recognition system 12 should preferably have a limit. Some person or group of persons should ultimately be able to countermand the judgment of the plan recognition system 12. The authorized users of the plan recognition system 12 should preferably know of its autonomy, its limits, and the protocol to override it. This information need not be widely shared, but its disclosure should not diminish its security.

The above description relates to an approach for the recognition of plans and goals. Also as described above, this approach can be improved by considering which plans and goals are abandoned by an agent.

The central realization of plan recognition as described above is that plans are executed dynamically and that, at any given moment, the agent is able to execute any one of the actions in its plans that have been enabled by its previous actions. In other words, the executing agent initially has a set of goals and chooses a set of plans to execute to achieve these goals. The set of plans chosen determines a set of pending primitive actions. The agent executes one of these pending actions, thus generating a new set of pending actions from which the next action will be chosen, and so forth.

An explanatory hypothesis is a set of goals, chosen plans, and observed actions that is valid if it explains all the observations. For each possible valid explanatory hypothesis, there is at least one corresponding series of pending sets. Pending sets are generated from previous sets by removing the action just executed and adding actions that are enabled by the executed action. This process is illustrated in FIG. 6 discussed above.

This view of plan execution provides a simple conceptual model for the generation of execution traces. To use this model to perform probabilistic plan recognition, the observations of the agent's actions are used as an execution trace, and one of a number of probabilistic reasoning algorithms, such the algorithm described above, may be used to infer a distribution over the root goals given the observations.

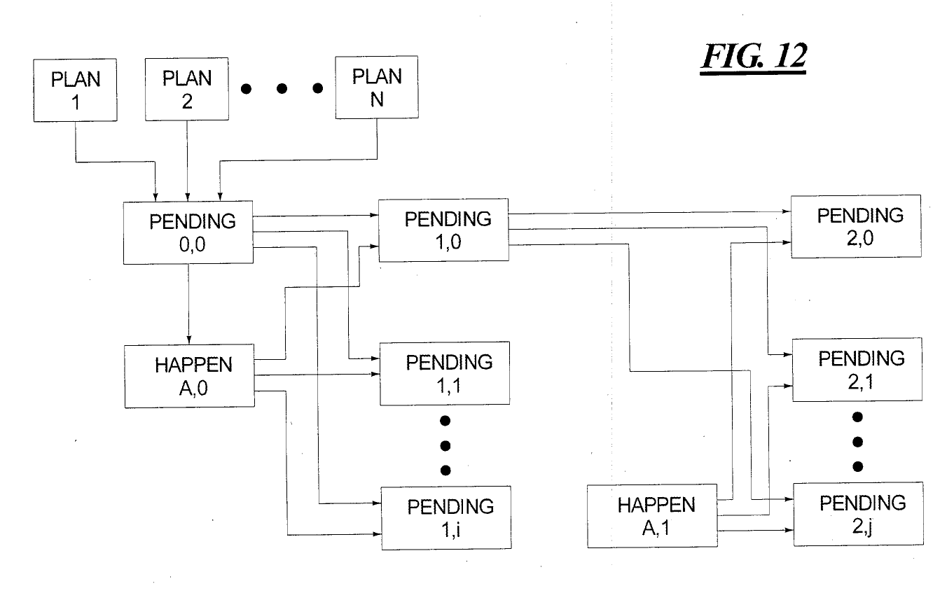

As indicated above, looking at information provided by pending sets is a critical component of plan recognition. Introducing the concept of plan abandonment into the plan recognition methodology changes the way in which pending sets are progressed. It may be assumed that, immediately after each action in the observation sequence, the agent is able to abandon any combination of one or more of the goals in its pending set. This means that the previous pending set and the action observed no longer uniquely determine the new pending set. The model of plan execution, therefore, moves from the one seen in FIG. 6 to that shown in FIG. 12.

The model of pending set progression is no longer deterministic. Previously, a pending set and an action execution in FIG. 6 yielded a unique pending set for the next time instant. However, as shown in FIG. 12, there are now multiple possible alternatives. In FIG. 12, these alternative pending sets are denoted as Pending(t,0), Pending(t,1), . . . , Pending(t,i), where t represents a time step. As represented by FIG. 6, the execution of an action generates a single unique new pending set by enabling new actions. However, as represented by FIG. 12, an agent now also chooses a set (possibly the empty set) of goals to be abandoned.

Since the agent may abandon any combination of goals at a time, the number of pending sets equals the number of possible subsets of the goals in the pending set that would have resulted without considering abandonment. That is, the new hypotheses correspond to the power-set of the goals in the original pending set. Thus, where the previous algorithm had to consider a single pending set as shown in FIG. 6, reliance on goal abandonment requires the examination of 2ⁿ pending sets for the next observation.

Next is a consideration of the computing of a value for the probability that a goal has been abandoned. In a model without goal abandonment, the probability of a given set of actions being observed (given the pending sets) can be formalizes-by the following expression:

$${\prod }_{i = 0}^{K} P ( happen ( {obs}_{i} , i ) \vert {PS}_{i} \qquad ( 4 )$$

where there are K observations, where happen(obsᵢ,i) means that the ith action in the observation stream is executed at time i, and where PSᵢ refers to the pending set at time i. Each of the terms of the product represents the probability that a particular action is chosen at that time from the pending set existing at that time. Thus, in this expression, P(happen(obsᵢ,i)|PSᵢ), expressed in words, is the probability that action in an observation stream will be executed at time i given the pending set of plans that exists at time i.

To compute the probability of an explanation when goal abandonment is considered, a term for the probabilistic abandonment of the goals (i.e. the transition from the current pending set to one of the 2ⁿ new pending sets) must be added to the above expression. This modified expression is given as follows:

$${\prod }_{i = 0}^{K} P ( happen ( {obs}_{i} , i \vert {PS}_{i} ) ) P ( {PS}_{i + 1} \vert {PS}_{i} , {obs}_{i} ) \qquad ( 5 )$$

Thus, the probability of observing a given set of actions (given the pending sets) when goal abandonment is considered is the product of the probability that an action in an observation stream will be executed at time i given the-pending set of plans that exists at time i and the probability that the pending set that will exist at time i+1 given the pending set at time i and the action in the observed stream at time i.

In other words, a probability measure over the set of pending sets is needed to capture how likely it is that the agent chooses to abandon that particular set of goals at that point in the sequence of observations. That is, for each pending set with n goals we will need the prior probability of its resulting in each of the 2ⁿ possible following pending sets (given the action that is observed to happen).

Acquiring these probabilities requires substantial effort. Even if the simplifying assumption that the abandonment of each of the goals is completely independent of all contextual factors (a highly dubious assumption) is made, knowledge of the probability that a given goal is abandoned is required.

To summarize, the-building of a fully general determination of probabilistic abandonment of goals in an exponentially larger space of possible execution traces is required to obtain the prior probabilities that each of the goals is abandoned.

Rather than explicitly considering all of the possible plans that could be abandoned, the problem can be looked at as a question of model revision. If a model of plan execution is used that does not consider plan abandonment to recognize observation streams in which the agent is abandoning plans, it can be expected that the computed probabilities for the observation streams will be quite low. Others have suggested that cases of an unexpectedly small P(observations|model) should be used as evidence of a model mismatch.

In the case where the recognition of a specific kind of model failure (namely that the agent is no longer executing a plan that it has begun) is of interest, the statistic of P(observations|model) is not sufficient. While this statistic drops rather rapidly when no evidence of the agent carrying out the steps of a plan is seen, it does not provide sufficient information to determine which of the agent's goals has been abandoned, the critical information needed to repair the model. Instead of the general P(observations|model) statistic, a more specific statistic is needed.

Suppose an agent is observed who, it is initially believed, has two high level goals, plan α and plan β. At the outset, the agent may mostly alternate the steps of the two plans. However, at about half way through, the agent stops working on plan β and instead only executes actions that are part of plan α. As the string of actions that contribute only to plan α gets longer, and no more actions that contribute to plan β are observed, it should be suspected that the agent has abandoned plan β.

This idea can be formalized as the probability that none of the observed actions in a sub-sequence (from say time s to time t) contribute to one of the goals, which may be referred to as G. This probability may be written as P(notContrib(G,s,t)|model,observations), which is the probability that the observed actions from time s to time t do not contribute to goal G, given the model and the observed actions. If this probability gets unexpectedly small, there is likely a mismatch between the model and the real world. Namely, the model predicts that the agent is still working on the goal, while the agent may have abandoned it. The following paragraphs detail how to compute this probability.

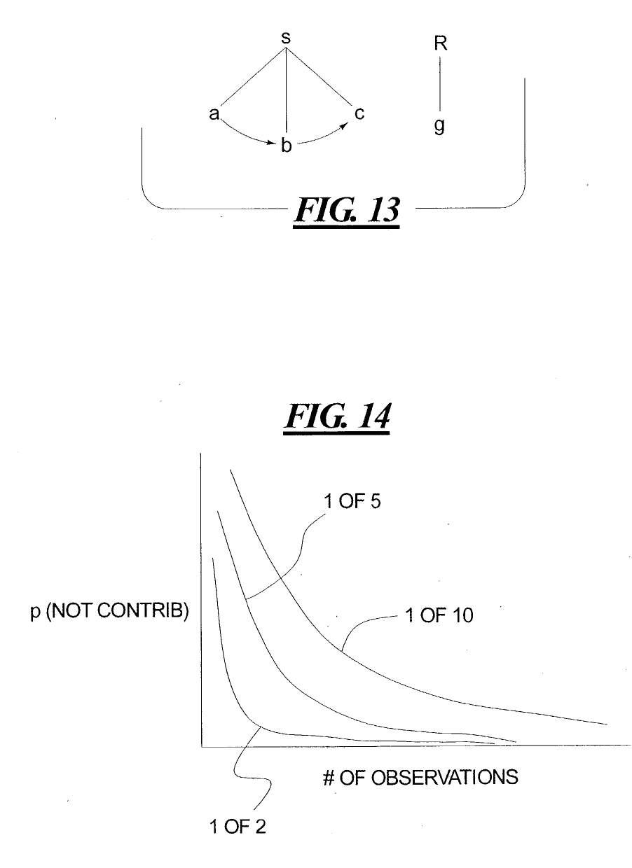

Consider the very simple plan library shown in FIG. 13. The first plan is a very simple plan for achieving goal S by executing actions a, b, and c, and the second plan is a very simple plan for achieving goal R by executing the single action g. Given this plan library, the following sequence of observations (observed actions) may be assumed:

happen(a,0), happen(b,1), happen(g,2), happen(g,3)

where happen(a,0), for example, indicates an observed action a at time 0.

In this case, we know that at time 0 and 1 that the agent has as a goal achieving S. Let it be assumed that all of the elements of the pending set are equally likely to be selected for execution next, an assumption that is made consistently throughout this discussion. However, nothing about the algorithm described herein hinges on this assumption.

Then, the probability of seeing action c occur at time 2 is given by the following expression:

$$\frac{m}{\vert {PS}_{2} \vert} \qquad ( 6 )$$

where m is the number of elements in the pending set of enabled actions that have c as the next action, and where |PS₂| is the magnitude or size of the pending set at time 2. An “element” of the pending set is an action instance and enough associated plan structure to uniquely identify the role that the action will play in the current explanation (if it is observed). In the example associated with FIG. 13, assuming a total of three root goals: S, two instances of R, m=1, because c is the only action instance in the pending set, and PS₂=3, because the pending set has the following three goals: S corresponding to happen(a,0) and happen(b,1); one instance of R corresponding to happen(g,2); and, one more instance of R corresponding to happen(g,3). Accordingly, the probability of seeing action c occur at time 2 is one-third.

The probability that c will not occur (that is, the probability that any other element of the pending set is chosen at time 2) is given by the following expression:

$$1 - \frac{m}{\vert {PS}_{2} \vert} . \qquad ( 7 )$$

In the example, the probability that c will not occur is two-thirds. More generally, the probability that b will be seen at time (S-1) and that c will not be seen by time t is given by the following expression:

$${\prod }_{i = s}^{t} ( 1 - \frac{{m}_{i}}{\vert {PS}_{i} \vert} ) \qquad ( 8 )$$

This expression adds time to the analysis and basically yields the probability that a particular action within the pending set will not occur between times s and t.

To handle partially ordered plans, this formula must be generalized slightly again. With partially ordered plans, it is possible for more than a single next action to contribute to the specified root goal. Thus, if m_{g,i} represents the number of elements (with any next action) in the pending set at time i that contribute to goal g, if (s-1) is the last time we saw an action contribute to g, and if t is the current time, then P(notContrib(g,s,t)|model,obs), which is the probability that the elements between the times s and t do not contribute to goal q, given the model and the observed actions, is given by the following expression:

$${\prod }_{i = s}^{t} ( 1 - \frac{{m}_{q , i}}{\vert {PS}_{i} \vert} ) \qquad ( 9 )$$

This expression computes the probability that none of the enable actions in the pending set will contribute to goal g between times s and t.

Thus, the probability of the sub-sequence of actions not contributing to a given plan or goal can be computed. Any drop in this computed probability below a selected threshold can be considered as sufficient evidence of a model mismatch, i.e., goals have been abandoned. The explanation can then be revised to reflect the abandoned goals. This revision requires the removal of all elements from the current pending set that contribute to the abandoned goal. Modeling of the execution of the rest of the plans can continue as before.

To summarize then, the explicit use of pending sets allows the computation of the probability that, if the agent still has a goal, then actions that contribute to the goal should be observed. If this probability gets large enough (note this is the inverse of the notContrib statistic), it may be assumed that the goal has been abandoned. Making the threshold for this decision a user defined parameter to the system allows the user to explicitly control how much evidence is required before the goal is assumed to be abandoned.

This approach creates an interesting linkage between the size of the pending set, the number of elements that contribute to the goal of interest, and the number of actions that do not contribute to the goal that must be observed before the goal is considered abandoned.

FIG. 14 shows three theoretical curves for the probability of notContrib for different sets of values. These curves are labeled with the number of actions that contribute to a goal and the size of the pending set. For example, the curve labeled “1 of 2” shows the drop in the probability given each observation if there is one action that contributes to the desired goal out of a pending set of size two. These curves assume that all of the actions in the pending set are equally likely to be chosen.

This graph highlights the relationship between the size of the pending set, the number of actions that contribute to the goal, the desired belief that an action that contributes to the goal should have seen, and the number of observations required to achieve that level of confidence. Notice that, as the ratio of the number of contributing actions to the size of the pending set drops, the number of actions required to drive notContrib down to a particular threshold value increases significantly.

The above description involves only the estimation of the probability that a given goal has been abandoned in a particular explanation for the set of observations. An explanation is defined as a unique set of goals, the plans to achieve those goals, and the actions necessary to carry out those plans. Accordingly, over the space of goals, plans, and actions that are based on the pending set, there are likely to be many explanations containing various combinations of those goals, plans, and actions. Estimating the probability that a given goal has actually been abandoned requires a further step.

If P(notContrib(g,s,t)|model,obs) is computed for each explanation and a threshold is applied to each such computation as described above, explanations of the observations in which goals have been abandoned can be produced. By considering the complete and covering set of such explanations for the observations, the probability of a specific goal's abandonment can be estimated. This probability is given by the following expression:

$$P ( abandoned ( g ) \vert Obs ) \approx \frac{{{\sum }_{e}}^{{Exp}_{A ( g )}} P ( e \vert Obs )}{{{\sum }_{e}}^{Exp} P ( e \vert Obs )} \qquad ( 11 )$$

where Exp represents the set of all explanations for the observations, and ExP_{A(g)} represents the set of explanations in which goal g is marked as abandoned.

The denominator of expression (11) may be computed by use of equation (1) or (2) described above and summing across all explanations. The numerator of the expression (11) may be computed in essentially the same manner except that the probabilities relative to the explanations corresponding to goals that have been-abandoned as determined by expression (9) and following thresholding are not included in the sum.

Certain modifications of the present invention will occur to those practicing in the art of the present invention. For example, as described above, the plan recognition system 12 monitors the identity and commands of the user 52. The user 52 has been shown as a human being. However, the user 52 need not be a human being. As a result, the plan recognition system 12 can be used to monitor the identity and commands of other systems such as computers.

In the above description, the plan recognition system 12 has been shown in connection with the protection of a chemical plant. However, the plan recognition system 12 can be used to protect other assets. In each case, the plans stored in the plan library are tailored to the specific application.

Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

We claim:

1. A plan recognition method, implemented by a processing system, comprising:
monitoring actions of a user;
recognizing a plan of the user based on the monitored actions; and,
recognizing an abandonment of the plan based on the monitored actions.

2. The plan recognition method of claim 1 wherein the recognizing of an abandonment of a plan comprises:
maintaining a pending set, wherein the pending set contains actions that are enabled by at least one of the monitored actions; and,
computing a probability that at least one action in the pending set will not be observed.

3. The plan recognition method of claim 2 wherein the recognizing of an abandonment of a plan further comprises applying a threshold to the computed probability.

4. The plan recognition method of claim 1 wherein the recognizing of an abandonment of a plan comprises:
maintaining a pending set, wherein the pending set contains actions that are enabled by at least one of the monitored actions; and,
computing a probability that at least one action in the pending set will not be observed between two points in time.

5. The plan recognition method of claim 4 wherein the recognizing of an abandonment of a plan further comprises applying a threshold to the computed probability.

6. The plan recognition method of claim 1 wherein the recognizing of an abandonment of a plan comprises:
maintaining a pending set, wherein the pending set contains actions that are enabled by at least one of the monitored actions; and,
computing a probability that all actions in the pending set required to carry out the plan will not be observed between two points in time.

7. The plan recognition method of claim 6 wherein the recognizing of an abandonment of a plan further comprises applying a threshold to the computed probability.

8. The plan recognition method of claim 1 wherein the recognizing of a plan of the user comprises recognizing a plurality of plans, wherein each plan has a goals and a set of actions necessary to carry out the plan, and wherein the recognizing of an abandonment of the plan based on the monitored actions comprises recognizing an abandonment of at least one of the plans.

9. The plan recognition method of claim 8 wherein the recognizing of an abandonment of a plan comprises:
maintaining a pending set, wherein the pending set contains actions that are enabled by at least one of the monitored actions; and,
computing a probability, based on explanations, that all actions in the pending set required to carry out the plans will not be observed between two points in time, wherein each explanation corresponds to a unique set of the goals, the plans to achieve the goals, and the actions to carry out the plans.

10. The plan recognition method of claim 9 wherein the computing of a probability comprises computing the probability based on first and second sums, wherein the first sum is determined by summing the probabilities of explanations relating to the pending set, and wherein the second sum is determined by removing from the first sum all probabilities of explanations related to all abandoned plans.

11. The plan recognition method of claim 10 wherein the computing of a probability comprises dividing the first and second sums.

12. The plan recognition method of claim 10 wherein the computing of a probability comprises dividing the second sum by the first sum.

13. The plan recognition method of claim 10 wherein the recognizing of an abandonment of a plan comprises:
maintaining a pending set, wherein the pending set contains actions that are enabled by at least one of the monitored actions;
computing a probability that all actions in the pending set required to carry out the plan will not be observed between two points in time; and,
determining that the plans have been abandoned based on the probability that all actions in the pending set required to carry out the plan will not be observed between two points in time.

14. The plan recognition method of claim 13 wherein the determining that the plans have been abandoned further comprises applying a threshold to the probability that all actions in the pending set required to carry out the plan will not be observed between two points in time.

15. A plan recognition method, implemented by a processing system, comprising:
maintaining a model to provide an estimate of whether plans of a user are normal or hostile;
monitoring actions of the user;
recognizing the plans of the user based on the monitored actions;
recognizing an abandonment of one or more of the plans based on the monitored actions; and,
processing the model in light of any plans recognized as abandoned.

16. The plan recognition method of claim 15 wherein the recognizing of an abandonment of one or more plans comprises:
maintaining a pending set, wherein the pending set contains actions that are enabled by at least one of the monitored actions; and,
computing a probability that at least one action in the pending set will not be observed.

17. The plan recognition method of claim 16 wherein the recognizing of an abandonment of one or more plans further comprises applying a threshold to the computed probability.

18. The plan recognition method of claim 15 wherein the recognizing of an abandonment of one or more plans comprises:
maintaining a pending set, wherein the pending set contains actions that are enabled by at least one of the monitored actions; and,
computing a probability that at least one action in the pending set will not be observed between two points in time.

19. The plan recognition method of claim 18 wherein the recognizing of an abandonment of one or more plans further comprises applying a threshold to the computed probability.

20. The plan recognition method of claim 15 wherein the recognizing of an abandonment of one or more plans comprises:
maintaining a pending set, wherein the pending set contains actions that are enabled by at least one of the monitored actions; and,
computing a probability that all actions in the pending set required to carry out the one or more plans will not be observed between two points in time.

21. The plan recognition method of claim 20 wherein the recognizing of an abandonment of a plan further comprises applying a threshold to the computed probability.

22. The plan recognition method of claim 15 wherein the recognizing of one or more plans of the user comprises recognizing a plurality of plans, wherein each plan has a goals and a set of actions necessary to carry out the plan, and wherein the recognizing of an abandonment of the plan based on the monitored actions comprises recognizing an abandonment of at least one of the plans.

23. The plan recognition method of claim 22 wherein the recognizing of an abandonment of one or more plans comprises:
maintaining a pending set, wherein the pending set contains actions that are enabled by at least one of the monitored actions; and,
computing a probability, based on explanations, that all actions in the pending set required to carry out the plans will not be observed between two points in time, wherein each explanation corresponds to a unique set of the goals, the plans to achieve the goals, and the actions to carry out the plans.

24. The plan recognition method of claim 23 wherein the computing of a probability comprises computing the probability based on first and second sums, wherein the first sum is determined by summing the probabilities of explanations relating to the pending set, and wherein the second sum is determined by removing from the first sum all probabilities of explanations related to all abandoned plans.

25. The plan recognition method of claim 24 wherein the computing of a probability comprises dividing the first and second sums.

26. The plan recognition method of claim 24 wherein the computing of a probability comprises dividing the second sum by the first sum.

27. The plan recognition method of claim 24 wherein the recognizing of an abandonment of a plan comprises:
maintaining a pending set, wherein the pending set contains actions that are enabled by at least one of the monitored actions;
computing a probability that all actions in the pending set required to carry out the plan will not be observed between two points in time; and,
determining that the plans have been abandoned based on the probability that all actions in the pending set required to carry out the plan will not be observed between two points in time.

28. The plan recognition method of claim 27 wherein the determining that the plans have been abandoned further comprises applying a threshold to the probability that all actions in the pending set required to carry out the plan will not be observed between two points in time.
